(19) United States
(12) Patent Application Publication
(10) Pub. No.: US 2002/0140206 A1
(43) Pub. Date: Oct. 3, 2002

(54) Trailer hitch towing member adapter

(76) Inventor: Michael J. Lloyd, Sandy, UT (US)

Correspondence Address: BRIAN C. TRASK, 3601 EAST HERMES DRIVE, SALT LAKE CITY, UT, 84124, US

(21) Appl. No.: 10/114,852

(22) Filed: Apr. 1, 2002

Related U.S. Application Data
(60) Provisional application No. 60/282,947, filed on Apr. 2, 2001.

(51) Int. Cl. B60D 1/00

(52) U.S. Cl. 280/491.5

(57) ABSTRACT

An adapter operable to connect a hook or chain double clevis to a tubular trailer hitch receiver. Certain embodiments are double-ended to permit either attachment of a larger D-ring to one end, or a hook or clevis to the opposite end.

### RELATED APPLICATIONS

This application claims the benefit under 35 U.S.C. 119(e) of the filing date of Provisional Application Serial No. 60/282,947, filed Apr. 2, 2001, for “TRAILER HITCH ADAPTER”.

### BACKGROUND

1. Field of the Invention

This invention relates generally to equipment and apparatus for towing vehicles. It particularly relates to adapters suitable to connect a chain or tow-strap to a commercially available tubular trailer hitch receiver.

2. State of the Art

Circumstances may arise, during the course of operating a vehicle, in which it may be desired to attach a towing member to the vehicle. Vehicles may slide off of a road and lose traction as a result of driving too fast in low visibility, icy, or other slippery conditions. Traction may also be lost while still on the road or desired path of travel. In one example, a vehicle may simply get stuck while attempting to drive in snowy conditions. In another example, driving off-road, a vehicle may get stuck in any number of terrain traps, including deep snow, muddy spots, water crossings, and loose sand. In the event a vehicle becomes stuck, a helper vehicle often-times can extract the stuck vehicle by way of a short towing operation using a towing member. Alternatively, a winch, or even a jack (such as a High-Lift™ jack), sometimes can be used to extract a stuck vehicle by providing tension on a towing member.

Typical towing members include lengths of chain, strong ropes, and resilient tow-straps. Chains can be attached to a vehicle with either a double clevis, or more commonly, with a grab hook. A chain with a grab hook at an end conveniently can be formed into a loop to attach to structure carried on either of the stuck or helper vehicle, such as a slip hook, or even bumper attach structure. Sometimes a chain's hook can be inserted into a hole in a frame member to form an attachment. A chain without end hooks sometimes can be attached using a double clevis to form an end loop. Some ropes, fashioned as dedicated automotive tow-ropes, have a hook on each end to permit attachment to a helper vehicle. Tow straps typically have either a slip hook or a loop at opposite ends of the strap. An end-loop commonly is formed in a tow strap by stitching a folded distal end portion of the strap onto a proximal portion of the strap. In any case, an end of the towing member is attached in some way to structure carried by the stuck vehicle, and tension is then applied to the towing member to extract the stuck vehicle.

While it sometimes is possible to attach a towing member to frame or bumper attach structure, such attachment may inconveniently entail crawling under the vehicle. In many cases, the person crawling under the vehicle to attach the towing member unavoidably will become wet or muddy. It is certainly preferred to accomplish attachment of the towing member without requiring such undue effort.

Attach structure for towing members is known, including solid hooks which can be mounted to a frame member, or bumper. Such hooks typically are permanently mounted to the vehicle, and lack any pivoting capability to align a hook with a direction of pull on the towing member.

A tubular trailer hitch, such as illustrated in FIG. 1, could serve as a convenient foundation for towing member attach structure. However, the size of the trailer ball opening is too large for fasteners of optimally sized hooks. The hook fasteners unavoidably would rattle around, and could improperly load or bind. Furthermore, desirable hooks are optimally sized to have adequate-strength and a small-size to facilitate their storage in a small volume. Commercially available such hooks have too small of a fastener reach (compared to the distance from the edge of a ball-mounting plate to a ball mounting hole) to permit passing the hook's fastener through an opening for a trailer ball. Furthermore, the ball mounting plate typically is too thick for receipt in the clevis gap provided by the desirable hooks. Even if the fastener could be received in the ball mounting hole, the mismatch between the diameter of the fastener and hole could contribute to a bearing or bending failure of the fastener.

An adapter for a large D-ring, illustrated in FIG. 2, is commercially available. However, due to both the large diameter of the hole in which the threaded D-ring stem is received and the thickness of the mounting plate, such an adapter is essentially specialized to receive only the large D-ring. Smaller D-rings, if capable of fitting on the plate, unavoidably wobble and rattle in the mounting hole, potentially being loaded in improper orientations. As with the trailer ball adapter, the mounting hole and plate thickness preclude mounting of optimally sized and commercially available slip and grab hooks to the commercially available D-ring adapter.

One commercially available tow hook, illustrated in FIG. 3, is removably installable in a tubular trailer hitch. While offering a measure of convenience for removable attachment, this hook arrangement lacks any swiveling capabilities to align with a load direction. Furthermore, the hook is welded to the adapter tube, forming a unitary assembly which requires a certain length for storage.

In many off-road vehicles, such as Jeeps, and small SUVs, limited space is available for storage. It therefore is desirable to provide a towing member attach structure in a removable and compact arrangement for storage in a tool box, or other container. A device permitting a hook to align in the direction of load from a towing member is desirable. An operable, convenient, and small device removably to mount an optimally sized slip or grab hook, or other towing member fastening structure, onto a vehicle is desired, and would be an improvement over available devices.

### SUMMARY OF THE INVENTION

The present invention provides an apparatus for mounting a towing implement in engagement with a tubular trailer hitch receiver. The invention includes a body having a first passageway in which to receive a commercially available hitch retaining pin to attach the body to the receiver. A first plate element protrudes from the body, a midplane of the first plate being oriented approximately parallel to a plane passing through the first passageway. The first plate carries a second passageway oriented approximately orthogonal to the first passageway. Typically, a centerline of the second passageway is spaced from an edge of the first plate element by a distance of about three-quarters of an inch. The adapter is generally constructed and arranged such that a towing implement carried by the first plate is rotatably positionable for connection to, and in at least partial alignment with, a towing member when the adapter is installed in the receiver. Towing members can include chains, ropes, and straps.

An exemplary embodiment of the invention has a body fashioned as a cylinder with its axis oriented generally parallel to the first passageway. Usually, the first plate element has a thickness of about one-half inch to receive commercially available hooks. Some embodiments of the invention include a second plate element, oriented approximately orthogonal to the first plate element, and disposed to protrude from an opposite side of the body from the first plate element, to permit reversible mounting of the adapter in the receiver. The second plate carries a third passageway oriented approximately orthogonal to the second passageway, and usually has a larger diameter hole to hold a D-ring of sufficient strength for pulling a vehicle. In reversible embodiments with two plates, the second passageway typically has a diameter of about one-half of an inch, and the third passageway has a diameter of about three-quarters of an inch.

An adapter according to the invention can be used in combination with a towing implement such as: a grab hook, a slip hook, a D-ring, or a chain double clevis. The implements are desirably rotatably connectable to the adapter by an easily removable fastener. Preferred adapters are structured in harmony with a mounting tube of the trailer hitch receiver to permit a hook to rotate, about a hook fastener axis, through an angle of approximately 90 degrees when the adapter is engaged in the mounting tube.

A currently preferred embodiment of the invention is fashioned as an adapter for mounting a towing implement in engagement with a tubular trailer hitch receiver. Typical such receivers are made from 2-inch square tubing. The currently preferred adapter has a cylindrical body with an axially oriented passageway sized to receive an adapter retaining pin to hold the body inside the receiver tube. A plate, having a thickness of about one-half inch, is affixed at one end to the body, a midplane of the plate being oriented approximately parallel to a plane passing through the first passageway. The plate includes a second passageway oriented approximately orthogonal to the first passageway, a centerline of the second passageway being spaced from an edge of the plate by a distance of about three-quarters of an inch to accommodate commercially available towing implements. The currently preferred adapter is constructed and arranged such that a towing implement attached to the plate is rotatably positionable for connection in at least partial alignment with a direction of pull from a towing member when the adapter is engaged in the receiver. Towing implements typically used with the preferred adapter include grab hooks, slip hooks, and chain double clevises.

These features, advantages, and alternative aspects of the present invention will be apparent to those skilled in the art from a consideration of the following detailed description taken in combination with the accompanying drawings.

### BRIEF DESCRIPTION OF THE DRAWINGS

In the drawings, which illustrate what is/are currently considered to be the best mode(s) for carrying out the invention:

FIG. 1 is an exploded view in perspective of a prior art tubular trailer hitch receiver mounted under a vehicle bumper and including a trailer hitch adapter to hold a trailer ball;

FIG. 2 is a view in perspective of a prior art D-ring and hitch adapter;

FIG. 3 is a view in perspective of a prior art removable fixed hook;

FIG. 4 is a view in perspective of a currently preferred embodiment of an adapter in combination with a slip hook;

FIG. 5 is a view in perspective of a first alternate adapter;

FIG. 6 is a view in perspective of a second alternate adapter;

FIG. 7 is a view in perspective of a third alternate adapter in combination with a grab hook;

FIG. 8 is a side view of a fourth alternate adapter that is reversibly mountable in a tubular receiver and in combination with a chain double clevis;

FIG. 9 is a view in perspective of a fifth alternate adapter; and

FIG. 10 is a view in perspective of a sixth alternate adapter that is reversibly mountable in a tubular trailer hitch receiver.

### DETAILED DESCRIPTION OF THE INVENTION

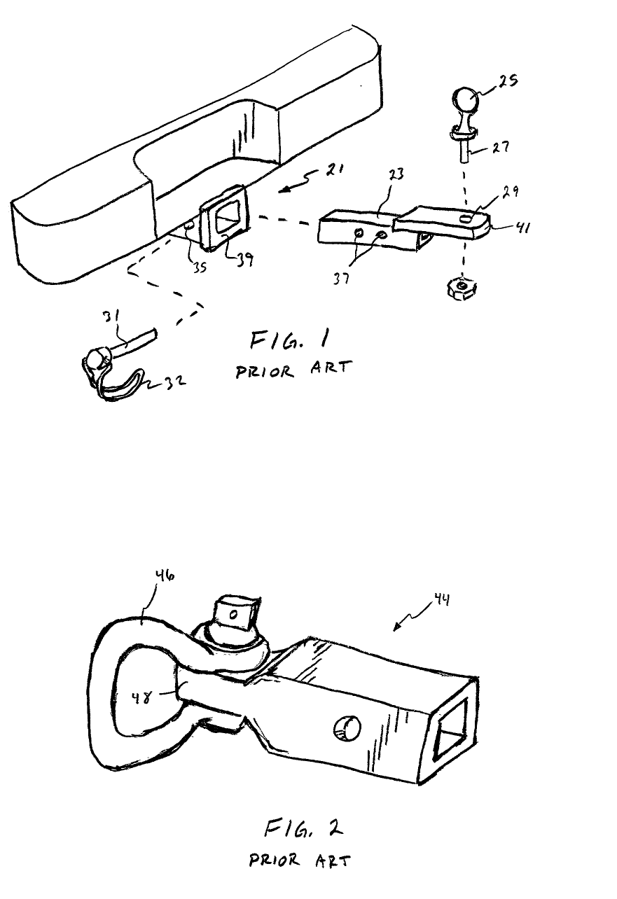

As illustrated in FIG. 1, a prior art tubular trailer hitch receiver, generally indicated at 21, can be mounted on a vehicle. The receiver 21 can be mounted in both front and rear vehicle locations. A prior art adapter 23 releasably holds a trailer ball 25 in registration with the receiver 21. Commonly available trailer balls 25 have threaded stems 27 of ¾ or 1 inch in diameter, which are received in ball mounting hole 29. The adapter 23 is generally affixed in the receiver 21 by one or more fasteners, such as pin 31. Illustrated pin 31 is retained for safety by a self-biased clip 32. Fasteners such as pin 31 generally have a ⅝ inch shaft diameter, and are received in correspondingly like-sized holes for safe load transfer between components of the hitch assembly. The shaft of pin 31 fits through receiver hole 35 and one of adapter retaining holes 37. Removal of the adapter is easily accomplished without tools by removing pin 31 and then sliding adapter 23 from engagement within the tubular receiver 39.

In certain situations, such as when a vehicle is stuck or attempting to retrieve a stuck vehicle, it is desirable to attach a towing member to each vehicle. Towing members typically include strong ropes, chains, and dedicated towing straps. An advantage of dedicated towing straps is their tendency to stretch under load and reduce shock loading as a vehicle first tightens the towing member. Towing members can have various end connection options, such as attached hooks, or formed to have end loops. A commercially available D-ring can make a suitable connector for a strap loop end.

D-rings are commercially available having sufficient strength for forming a safe connection between an adapter 23 and a towing strap member. Such a D-ring can be installed in replacement of the ball 25. D-rings suitably sized for such purpose have a retaining pin sized at least in approximate agreement with the diameter of the ball retaining hole 29. Furthermore, such size D-rings have a span between open ends sufficient to accommodate the thickness of a ball mounting plate 41.

A commercially available adapter, generally indicated at 44, to attach a D-ring 46 to a receiver 21 is illustrated in FIG. 2. A special purpose adapter such as adapter 44 can save storage room in a vehicle, since the adapter length can be shorter than for adapter 23. However, the adapter 44 cannot receive hooks of an optimum space-saving, and sufficiently-strong, size. Such hooks typically have a retaining pin of about ⅜ to ½ inch in diameter. Furthermore, the clevis portion of optimum sized hooks is too narrow to accommodate the thickness of the mounting plate 48.

One commercially available solution for removably attaching a hook to a receiver 21 is generally indicated at 50 in FIG. 3. Removable hook adapter 50 has a hook portion 52 welded to a square tube portion 54. The hook portion 52 is therefore fixed in one single orientation after the tube portion 54 is installed in a tubular receiver 39. This fixed orientation detrimentally can cause the hook 52 to be bent or distorted if a load from a towing member is applied at an angle to the hook shaft 56. Such off-axis loads are inevitable in retrieving vehicles that are stuck off of a road.

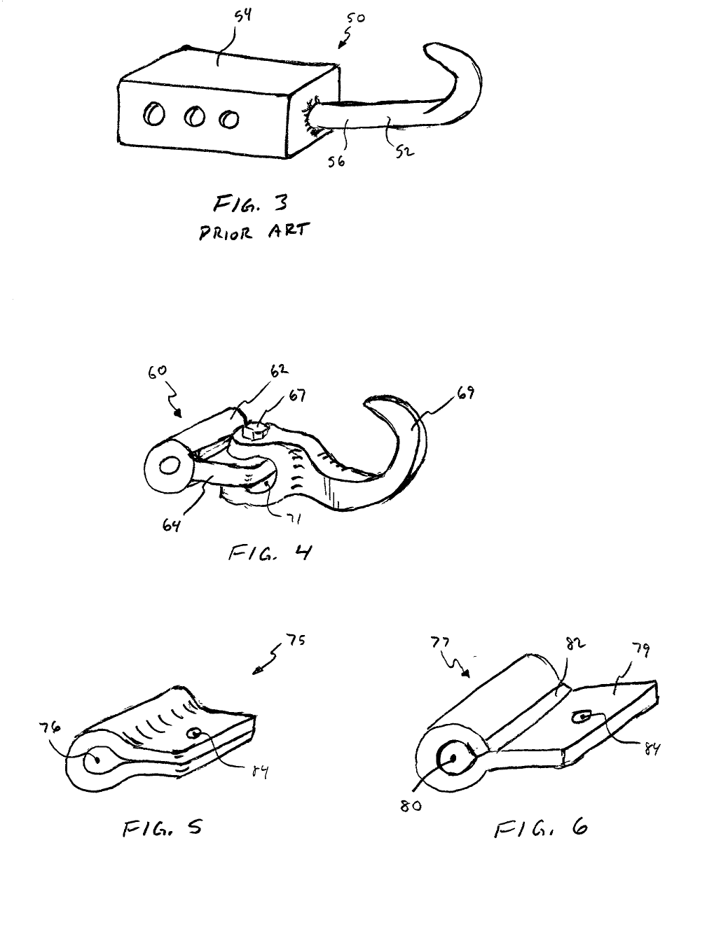

A preferred embodiment of the invention, generally indicated at 60 in FIG. 4, addresses the deficiencies of the prior art devices. Adapter 60 has an approximately 2 inch long cylindrical body 62 from which protrudes a plate 64. Bodies may be made having other lengths to fit into other sized tubular receivers 39. Plate 64 has a hole in which to receive a fastener of a towing implement, such as bolt 67 of slip hook 69. The implement fastening arrangement of the invention permits an implement, such as a hook 69, to rotate and align with a load direction from a towing member. Furthermore, the plate 64 has a thickness to provide sufficient strength for towing loads, but thin enough to fit into a hook clevis, such as clevis area 71 of hook 69. Hook 69 is a slip hook, and it has been determined that a ⅜ inch slip hook is about an optimal size, accounting for hook strength and size.

The invention is typically made from steel, although other metals and materials having sufficient strength and durability may be used. Illustrated plate 64, in FIG. 4, is attached to body 62 by welding the components together. Workable manufacturing techniques to form the invention include casting, forging, and welding separate components together. Alternative embodiments of an adapter are illustrated in FIGS. 5-10.

In certain preferred embodiments of the invention, a fastener attaching a towing implement, such as bolt 67 in FIG. 4, is sized having a length small enough to slide into reception inside a receiver tube 39 to permit a reduction in a length of adapter 60. Such configuration permits adapter 60 to be stored in a smaller volume. In certain such embodiments, the hook portion 69 may still swivel a certain amount to align hook 69 with a load direction from a towing member. Typically and desirably, the invention can rotate a hook 69 through a 90 degree arc, or more.

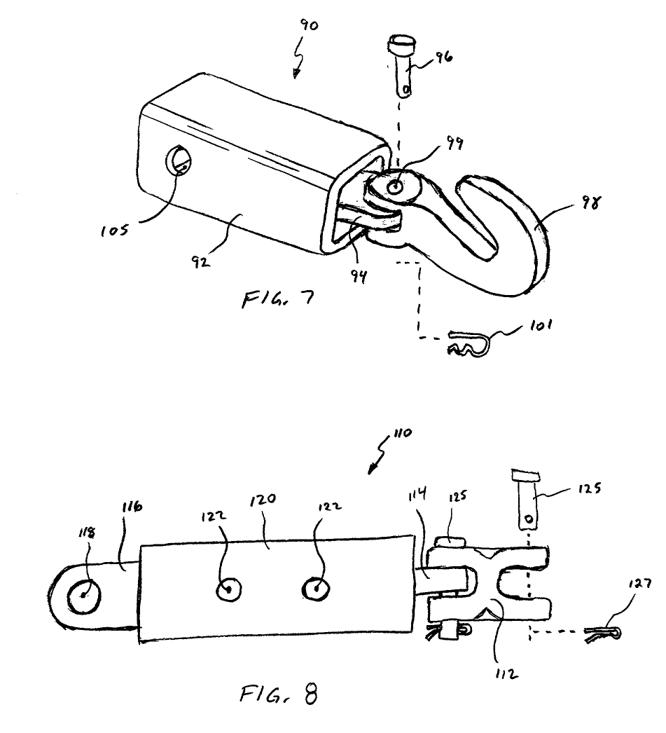

Adapter 75 in FIG. 5 is formed from a single sheet of material, folded to form passageway 76 in which to receive a retainer, such as pin 3 1. Adapter 77, in FIG. 6 10 is formed by bending one end of a plate 79 into an approximate circle to form passageway 80. The bent end is then desirably affixed by weld 82. Each of adapters 75 and 77 have a passageway 84 in which to receive a fastener for a towing implement, such as slip hook 69. Passageways 84 are typically between about ⅜ and about ½ inch in diameter to receive fasteners for various hooks or double clevises.

FIG. 7 illustrates another alternative embodiment of an adapter, generally indicated at 90, to hold a towing implement in registration with a tubular trailer hitch receiver. Adapter 90 is formed from a tubular section 92, and a plate section 94. Plate section 94 typically has a thickness of about ⅜ to ½ inch, and is welded to the inside of tubular section 92. Plate 94 carries a passageway in which to receive fastener 96 of grab hook 98. The passageway carried by plate 94 desirably is sized in agreement with passageway 99 in hook 98. Pin 98 permits hook 98 to rotate to align with a load from a towing member. Tool-free assembly and disassembly can be accomplished by use of a safety retainer, such as self-biased clip 101. A similar retainer, such as pin 31 in FIG. 1, is installed through passageway 105 to hold the adapter 90 in registration with a receiver tube 39. A workable sized hook 98 includes a 7/16 inch grab hook, although other sizes also are acceptable.

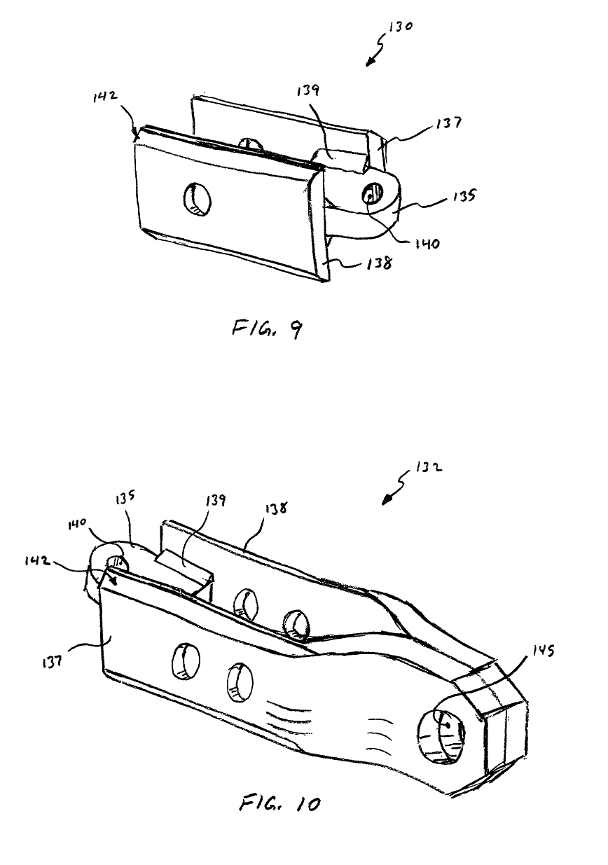

A double-ended adapter, generally indicated at 10, is shown in FIG. 8. Adapter 110 permits use of a hook or double clevis 112 on one end, and a larger D-ring, such as D-ring 46 in FIG. 2, on the other end. Adapter 110 is essentially a stretched version of adapter 90, having a plate 114 corresponding to a plate 94. Additionally, a plate 116 carries a passageway 118 sized to receive a D-ring 46. Plates 114, 116 are both typically welded to the inside of tubular section 120, which is sized to fit into a tubular receiver 39. Adapter 110 may be retained in registration with a receiver 21 by a fastener 31 placed into reception in one of passageways 122 and passageway 35.

Plate 116 desirably is oriented 90 degrees from plate 114 to orient the D-ring 46 in a preferred orientation. A horizontal D-ring 46 is best able to maintain registration with a hook until tension can be applied to the towing member carrying the hook, which then maintains engagement between the towing member and the D-ring. As with plates 64 and 94, plate 114 desirably is oriented on installation in a receiver tube 39 to maintain a hook in a vertical orientation so a towing member, such as a strap, will be maintained captive in the hook until tension is applied to the strap.

Double clevis 112 is typically sized in correspondence with a section of chain of sufficient strength to withstand towing loads. Typical chain sizes range from ¼ inch to about ½ inch, with about ⅜ inch chain generally being preferred. Clevis 112 typically has a pair of fastener pins 125 that are held in position by safety retainers, such as cotter pins 127.

Adapters, such as embodiments generally indicated at 130 and 132 in FIGS. 9 and 10, may be manufactured by welding together strap component elements. Adapter 130 has a plate 135 affixed to plates 137 and 138 by welds, such as weld 139. Plate 135 carries a passageway 140, sized and oriented to receive a fastener for a hook or double chain clevis. It is preferred to chamfer or radius the corners, generally indicated at 142, to reduce rattling of the adapter in a receiver tube 39. Plates 137, 138 forming sides of adapter 132 are bent at one end to form a plate carrying passageway 145 to optionally hold a D-ring. Adapter 132 therefore can reversibly be inserted into a receiver tube 39 to provide an anchor for a hook, clevis, or suitably sized D-ring.

While the invention has been described in particular with reference to certain illustrated embodiments, such is not intended to limit the scope of the invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An adapter for mounting a towing implement in engagement with a tubular trailer hitch receiver, the adapter comprising:
a body comprising a first passageway in which to receive a hitch retaining pin for purpose of attaching said body to said receiver; and
a first plate element protruding from said body, a midplane of said first plate being oriented approximately parallel to a plane passing through said first passageway, said first plate comprising a second passageway oriented approximately orthogonal to said first passageway; wherein:
said adapter is constructed and arranged such that a towing implement carried by said first plate is rotatably positionable for connection to a towing member when said adapter is engaged in said receiver.

2. The adapter of claim 1, wherein:
said body comprises a cylinder having a cylinder axis oriented generally parallel to said first passageway.

3. The adapter of claim 1, in combination with a towing implement comprising a grab hook connectable to said adapter by a fastener passing through said second passageway.

4. The adapter of claim 1, in combination with a towing implement comprising a slip hook connectable to said adapter by a fastener passing through said second passageway.

5. The adapter of claim 1, in combination with a towing implement comprising a chain double clevis connectable to said adapter by a fastener passing through said second passageway.

6. The adapter of claim 3, said adapter being structured in harmony with a mounting tube of said receiver to permit said grab hook to rotate, about a hook fastener axis, through an angle comprising approximately 90 degrees when said adapter is engaged in said mounting tube.

7. The adapter of claim 4, said adapter being structured in harmony with a mounting tube of said receiver to permit said slip hook to rotate, about a hook fastener axis, through an angle comprising approximately 90 degrees when said adapter is engaged in said mounting tube.

8. The adapter of claim 1, further comprising:
a second plate element, oriented approximately orthogonal to said first plate element and disposed to protrude from an opposite side of said body from said first plate element to permit reversible mounting of said adapter in said receiver;
a third passageway passing through said second plate element being approximately orthogonal to said second passageway.

9. The adapter of claim 8, wherein:
said second passageway has a diameter of about one-half of an inch; and
said third passageway has a diameter of about three-quarters of an inch.

10. The adapter of claim 8, in combination with a towing implement comprising a D-ring connectable to said adapter by way of a fastener passing through said third passageway.

11. A device to connect a towing member to a tubular hitch receiver, comprising:
a body adapted for connection to said receiver; and
a first mounting plate element carrying a first mounting hole, having an approximately ½ inch diameter, oriented and arranged for rotatable connection to a towing implement comprising a hook, said first plate element being affixed at a first end to said body and having a thickness for reception between arms carried at a connection end of said hook.

12. The device according to claim 11, in combination with a said hook.

13. The device according to claim 12, said hook being a grab hook.

14. The device according to claim 12, said hook being a slip hook.

15. The device according to claim 11, in combination with a chain double clevis.

16. The device according to claim 12, further comprising:
a second mounting plate element carrying a second mounting hole, having an approximately ¾ inch diameter, oriented and arranged for rotatable connection to a towing implement comprising a D-ring, said second plate being affixed to said body on an opposite side of said body from said first plate, said device being configured for reversible installation in said receiver to permit alternate connection of either a hook or a D-ring to said receiver.

17. The device according to claim 16, in combination with a D-ring.

18. An adapter for mounting a towing implement in engagement with a tubular trailer hitch receiver, the adapter comprising:
a cylindrical body having a cylinder axis oriented generally parallel to a first passageway passing through said body, said passageway being sized to receive an adapter retaining pin for purpose of attaching said body to said receiver; and
a first plate element, having a thickness of about one-half inch, affixed at a first end to said body, a midplane of said first plate being oriented approximately parallel to a plane passing through said first passageway, said first plate comprising a second passageway oriented approximately orthogonal to said first passageway, a centerline of said second passageway being spaced from an edge of said first plate element by a distance of about three-quarters of an inch; wherein:
said adapter is constructed and arranged such that a towing implement attached to said first plate is rotatably positionable for connection in at least partial alignment with a direction of pull from a towing member when said adapter is engaged in said receiver.

19. The adapter of claim 18, in combination with a towing implement comprising a hook connectable to said adapter by way of a fastener passing through said second passageway.

20. The adapter of claim 18, in combination with a towing implement comprising a chain double clevis connectable to said adapter by way of a fastener passing through said second passageway.
